(19) United States
(12) Patent Application Publication
(10) Pub. No.: US 2014/0026758 A1
(43) Pub. Date: Jan. 30, 2014

(54) Flavor Infusion Pitcher

(71) Applicant: Paul Santarsiero, Avon, CT (US)

(72) Inventor: Paul Santarsiero, Avon, CT (US)

(21) Appl. No.: 13/560,597

(22) Filed: Jul. 27, 2012

(51) Int. Cl. A47J 31/44

(52) U.S. Cl. 99/279

(57) ABSTRACT

A means of suspending flavor medium(s) within a pitcher or vessel containing a consumable liquid. The flavor medium(s) is retained by a removable, substantially central stem(s) which locates to and extends into the vessel. The stem(s) can be made of Stainless Steel, wood, or plastic and be flexible or rigid. The stem can be configurable to be “U” shaped, helical shaped, zigzag shaped, or other shape that aids in retaining fruit, herbs, or other desirable flavor medium(s). The stem functions to hold flavor medium(s) in place while submerging them and while pouring from the vessel. The flavor medium(s) are to be pierced or held under tension while submerged, and function to transfer flavor enhancement to the vessel's beverage with proportional strength to the length of time they are allowed to meld. The insertion of the stem and flavor medium(s) inside the vessel also functions to create an aesthetically pleasing presentation.

### BACKGROUND OF THE INVENTION

It is well known that consumers desire to modify and make homemade drinks with the added zest of natural or manmade flavor enhancement through secondary sources of flavor infusion. Infusion Pitchers are presently on the market and offer many options for the consumer to customize their drink. The following United States patent documents represent prior art that could be considered germane to the present invention:
U.S. Pat. No. 489,468
U.S. Pat. No. 1,858,435
U.S. Pat. No. 2,176,377
U.S. Pat. No. 3,755,895
U.S. Pat. No. 4,215,628
U.S. Pat. No. 4,228,338
U.S. Pat. No. 4,359,283
U.S. Pat. No. 4,460,279
U.S. Pat. No. 4,650,583
U.S. Pat. No. 4,806,369
U.S. Pat. No. 4,849,231
U.S. Pat. No. 4,871,555
U.S. Pat. No. 4,89,1232
U.S. Pat. No. 4,893,940
U.S. Pat. No. 318,791
U.S. Pat. No. 388,729
U.S. Pat. No. 5,586,676
U.S. Pat. No. 5,623,865
U.S. Pat. No. 6,186,052
U.S. Pat. No. 6,224,253
U.S. Pat. No. 6,231,226
U.S. Pat. No. 6,314,866
U.S. Pat. No. 6,482,451
U.S. Pat. No. 6,692,780
U.S. Patent No. US20070151461
U.S. Patent No. US20110241362
U.S. Patent No. US20110241363
U.S. Patent No. US20110300275
U.S. Pat. No. USD498967
U.S. Pat. No. USD511933

A variety of flavor infusion pitchers and drink containment devices have been developed and marketed. More recently, the consumer has seen new product offerings in the areas of ice tea pitchers, lemonade pitchers, and sangria pitchers that allow the consumer to insert cut-up lemons, herbs, mint leaves, or other fruit into the pitcher center by having an interior cavity with which to contain these afore mentioned flavor mediums. However, until now, a device does not exist which suspends the flavor medium(s) within a vessel through the use of an internal removable and locatable stem. This stem positively locates to the vessel. Existing products require the user to insert the cut-up flavor mediums into a chamber inside the pitcher. This chamber in turn must have slots and/or perforated holes to allow for flavor transferal from the flavor medium to the liquid surrounding it. The invention utilizes a stem which positively contains flavor infusion fruit, vegetables, herbs, or other natural and man-made flavors sources, and positively locate them to a beverage vessel allowing for a simpler and more elegant design, while at the same time offering lower manufacturing cost and a greater ease of cleaning the product after use.

### SUMMARY OF THE INVENTION

People have ongoing needs to stay hydrated and enjoy healthful refreshing drinks especially during the summer months. More recently, the consumer has shown a strong desire to make healthy drinks for themselves and family. It is well known that inserting cut or whole fruit, mint leaves or other flavor sources into a pitcher containing tea, lemonade or just plan tap water will transfer flavor from these flavor mediums to the liquid inside and that the flavor transferal increases with the length of time these flavor mediums stay in contact with the beverage. These flavor mediums while contained on or by the inventions stem also have a secondary function of bolstering the visual appeal of the beverage.

The present invention:

A means of suspending flavor medium(s) within a vessel containing a consumable liquid. The said flavor medium(s) is retained by an internal stem that is removable and positively locates to the vessel. This stem and/or stem assembly can positively located to the pitchers lid, or in the absence of a lid, be inserted to be retained on a deliberate location on the vessel, such as the top rim, a handle extension, or a fixed area extending from the top of the vessel. In all versions, the stem is easily removed for the insertion of the flavor medium(s) on it and easily re-inserted to be retained on the beverage vessel. This stem and stem assembly can be made of Stainless steel, electroplated steel, plastic, wood, or other food contact approved material and be configured to have a variety of shapes, such as a “U” shape, a helical shape, a zigzag shape, or other shape that retains cut or whole fruit, herbs, or other desirable natural or man-made flavor medium(s). This stem functions to hold flavor medium(s) in place while the liquid in the vessel surrounds it and to locate the assembly to the vessel or vessel lid. The flavor medium(s) and stem subassembly are lowered into a chosen beverage contained in the vessel allowing them to steep flavor to the beverage while being contained on or by the stem. The end user further benefits from the flavor medium staying in place while dispensing liquid from the vessel, while at the same time allowing the medium to be pierced or compressed and in full contact with the liquid, transferring the medium's flavor to the liquid with proportional strength to the length of time the flavor medium and liquid are allowed to meld.

### BRIEF DESCRIPTION OF THE ILLUSTRATED EMBODIMENTS

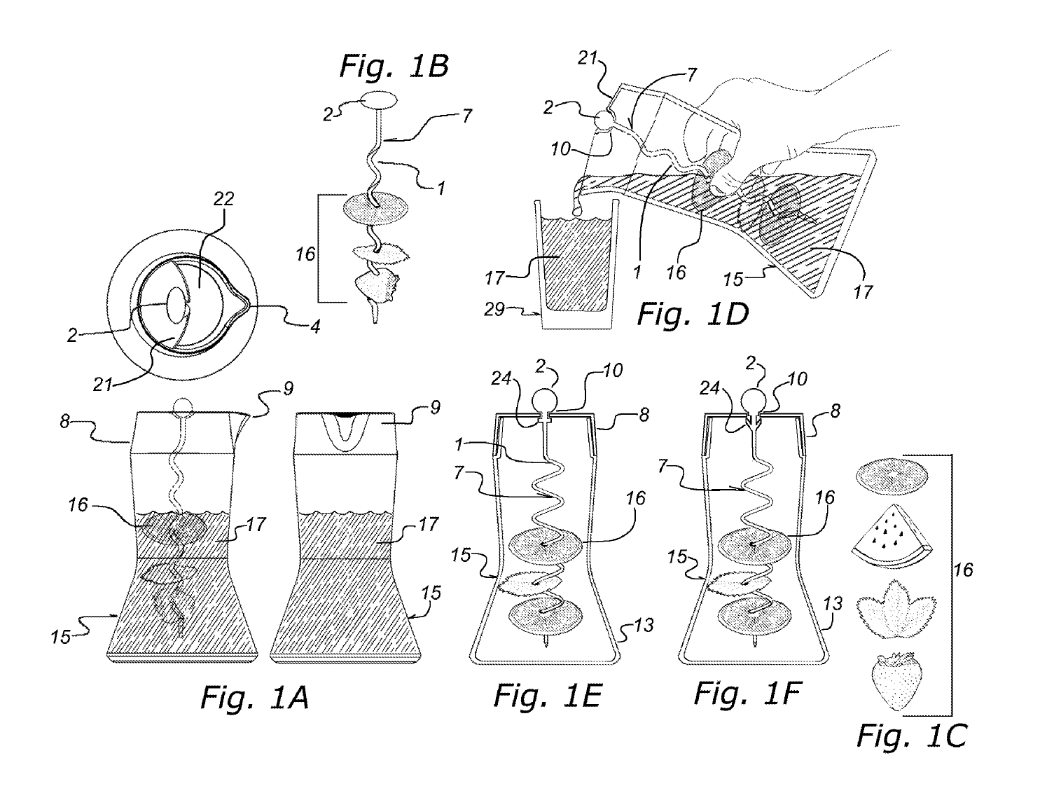

FIG. 1A illustrates three orthographic views; top, side, and front views showing an exemplary beverage infusion pitcher 15, without a handle. The top view shows area 22 which has an opening from which to pour beverages from and a closed planar surface 21 that partially restricts the top opening of the pitcher 15.

FIG. 1B illustrates the stem subassembly 7 containing a central helical stem 1, containing fruit and herb leaves 16, shown before submerging it into the pre-infused liquid beverage 17.

FIG. 1C illustrates fruit and herb leaves that are exemplary of flavor mediums to be inserted onto the stem subassembly 7.

FIG. 1D illustrates the subassembly stem 7 and the central helical stem 1 containing fruit and herb leaves 16, and shown in its fixed location 10 when pouring the flavor infused liquid beverage 17 into a drinking glass 29. Grip knob 2 is shown positively located to its receptor recess 10 which keeps stem assembly located to pitcher 15 on its partial top plan 21.

FIG. 1E illustrates a lateral sectional view of pitcher assembly 15 showing stem subassembly 7 and an alternate means for fastening stem assembly 7 to the pitcher 15 top fixed part 8. Grip knob 2 of Stem subassembly 7 slides to locate onto part 8 and its raised disk protrusion 24 which functions to retain the assembly in place.

FIG. 1F illustrates a sectional view of pitcher assembly 15 showing stem subassembly 7 and an alternate arrangement for fastening stem assembly 7 to pitcher top 8. A detent or friction hold point 24 is employed to allow stem subassembly 7 to remain fastened in place.

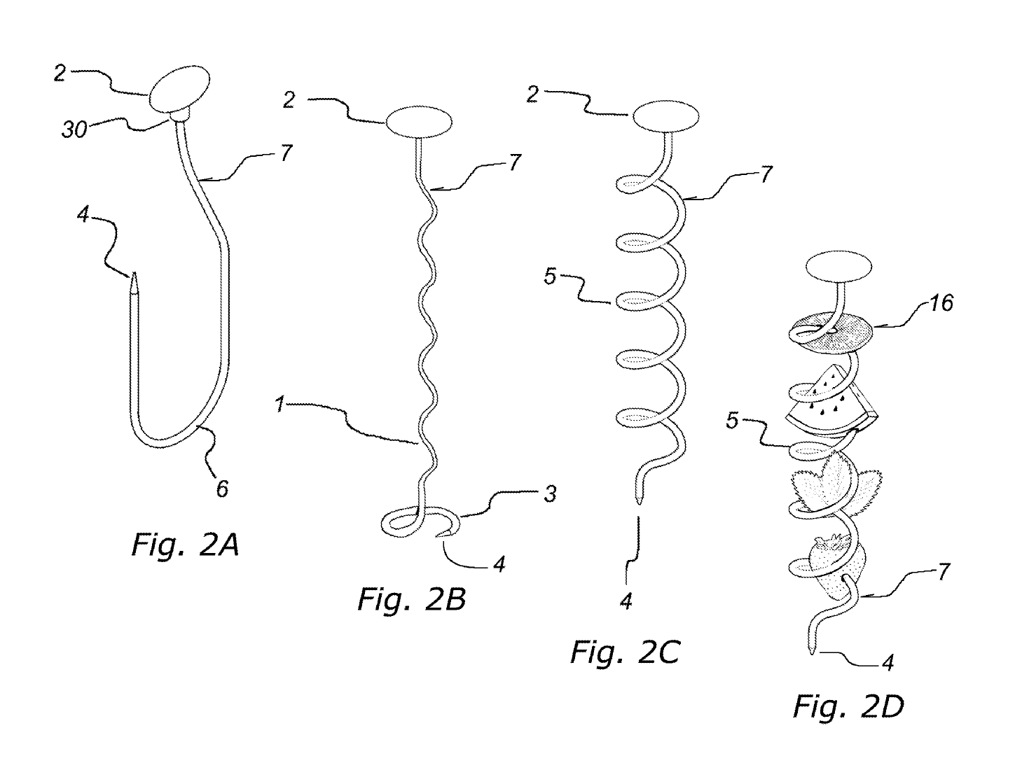

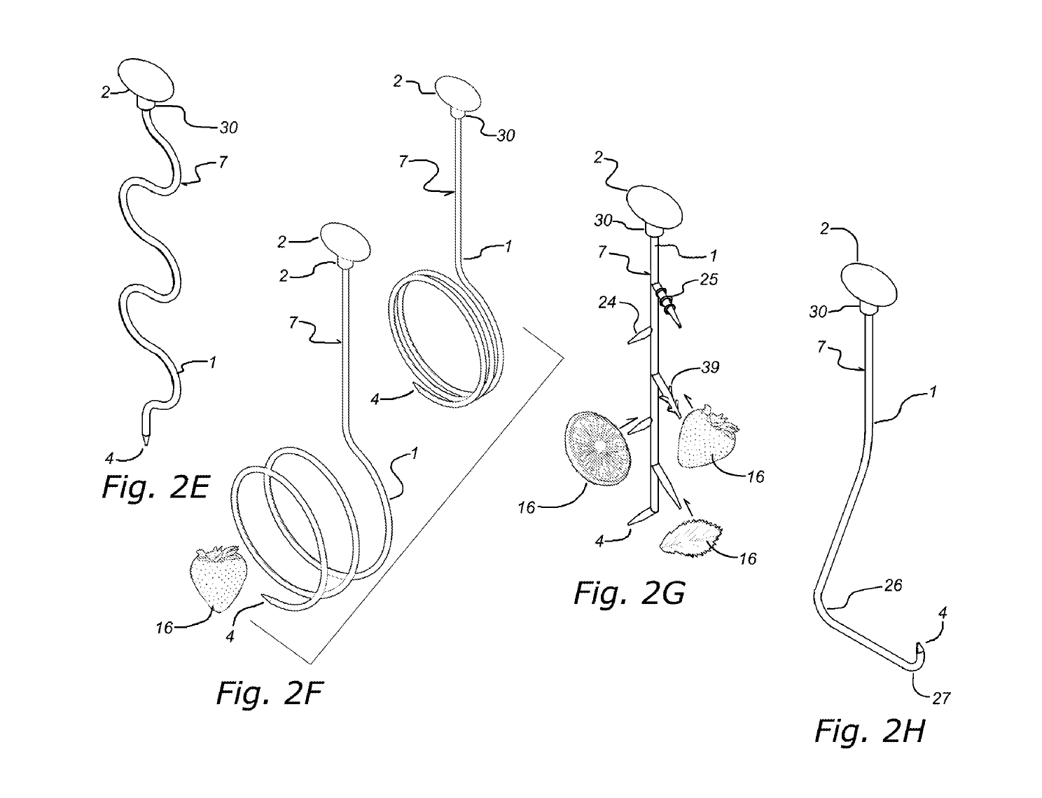

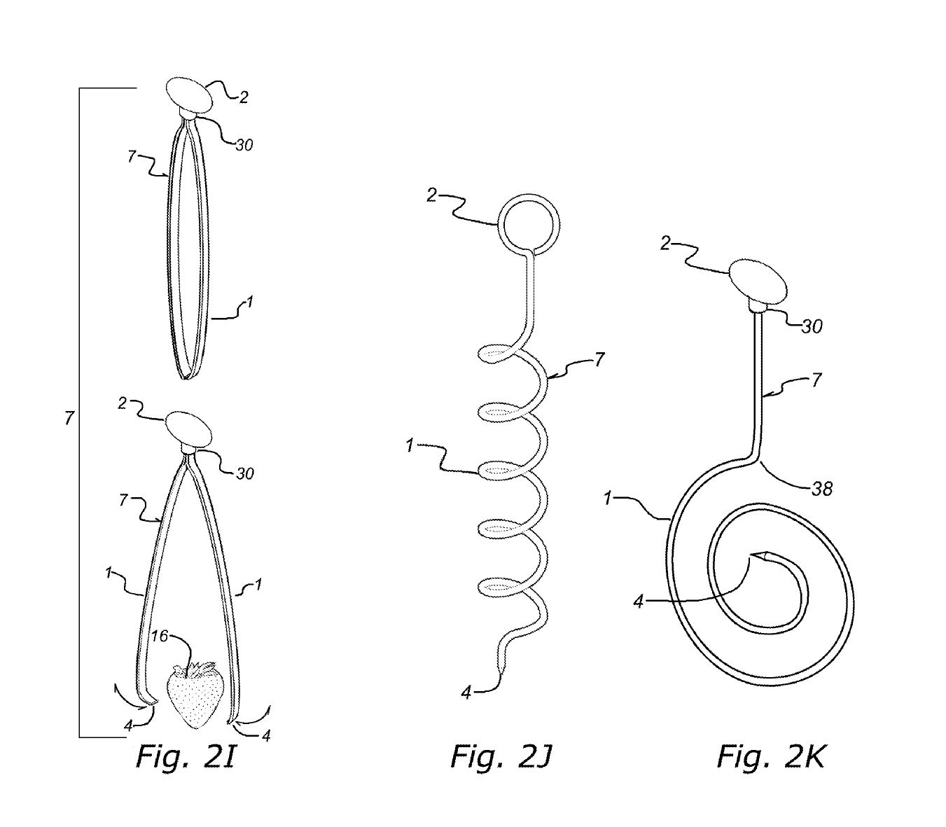

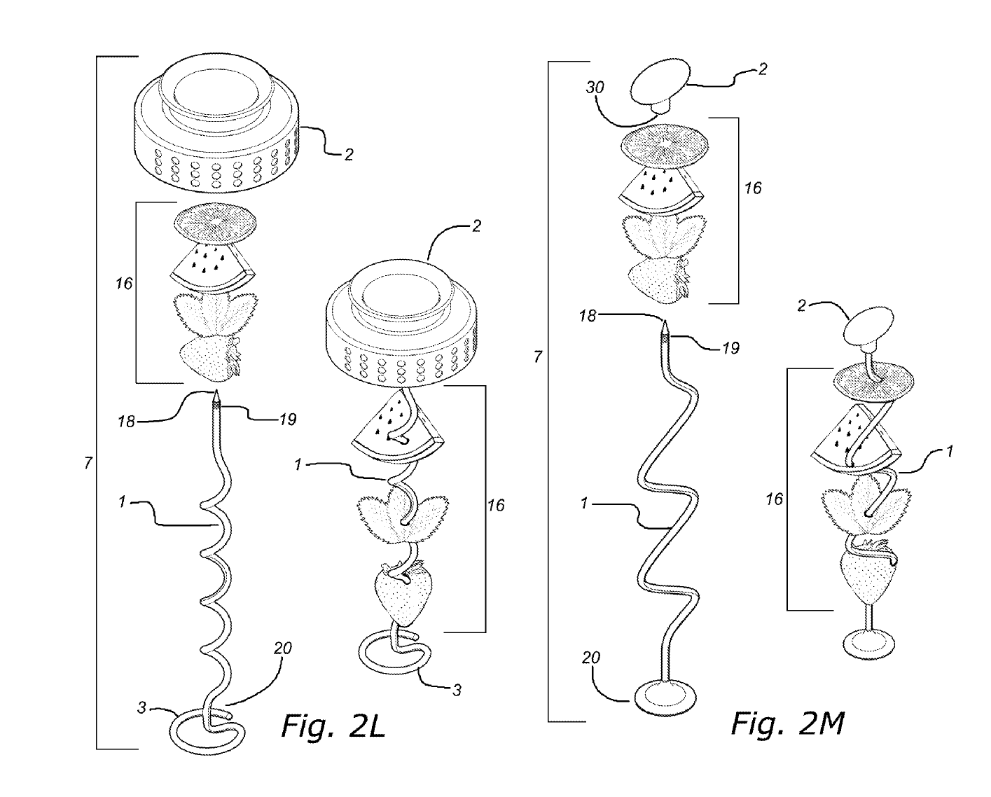

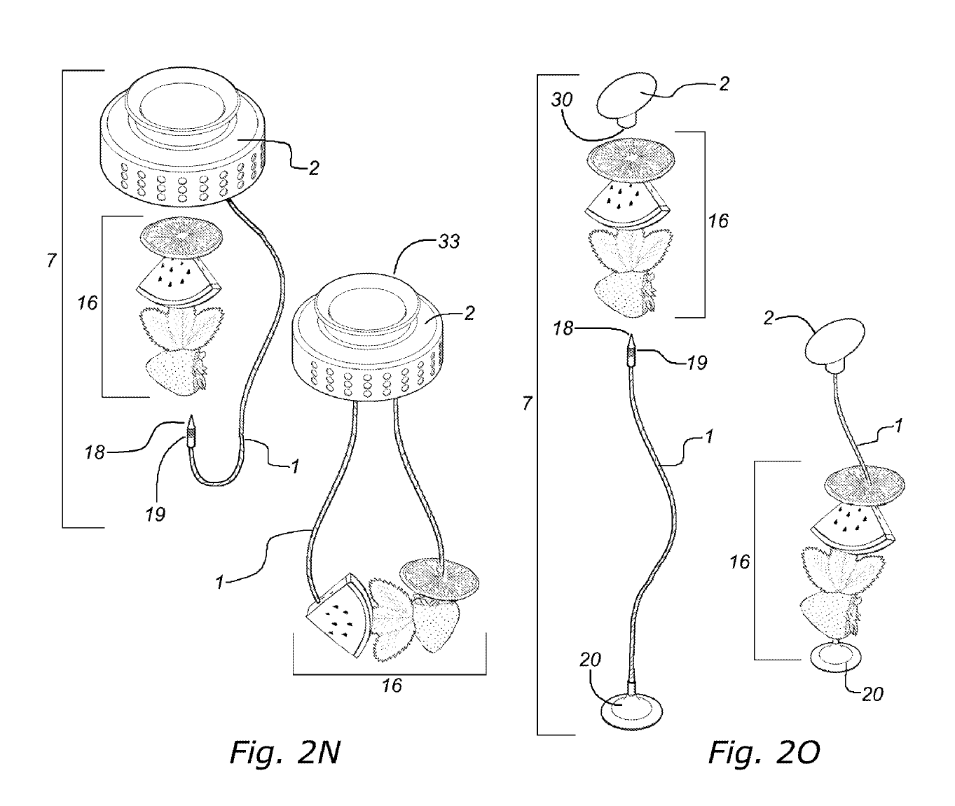

FIG. 2A illustrates an exemplary infusion medium containment stem subassembly 7 that is “U” shaped, has a grip knob 2, and a “U” shape rod 6, which ends in a chamfered point 4 to aid in piercing fruit, vegetables and herbs. Once these flavor mediums are inserted onto stem 6 they are held in place anchored to stem assembly 7.

FIG. 2B illustrates an exemplary infusion medium containment stem subassembly 7 that is helical shaped, has a grip knob 2, a helical stem 1, and whose bottom ends with planar radius 3 which functions to hold flavor mediums above it. Flavor medium(s) 16 are to be inserted onto the tapered point 4 and treaded up the helical stem 1. Once these flavor mediums are intersected by stem 1, both its helical shape and the planar radius ensure they remain anchored to stem 1.

FIG. 2C illustrates an exemplary infusion medium containment stem subassembly 7 that has a wider helical shaped stem 5 as compared to the helical stem in FIG. 2B, has a grip knob 2, and which ends in a downward facing tapered point 4 to aid in piercing fruit, vegetables, herbs, and other flavor mediums. Once these flavor mediums are inserted onto stem 5, its wide helical shape aids in retaining flavor mediums.

FIG. 2D illustrates the above FIG. 2C stem subassembly 7 shown with fruit and herbs inserted on helical shaft 5 and contained with each fruit and herb held at their own independent location on skewer.

FIG. 2E illustrates an exemplary infusion medium containment stem subassembly 7 that has a radius zigzag shape to part 1, has a grip knob 2, and ends with a downward facing tapered point 4 to aid in piercing fruit, vegetables, herbs and other flavor mediums.

FIG. 2F illustrates an exemplary infusion medium containment stem subassembly 7 that has a tightly spaced lateral helical progression at its bottom half, has a grip knob 2, a vertical stem 1, and ends with a downward facing tapered point 4 to aid in piercing fruit, vegetables, herbs and other flavor mediums.

FIG. 2G illustrates exemplary infusion medium containment stem subassembly 7 that has multiple lateral stems 24, has a grip knob 2, a central stem 1.

FIG. 2H illustrates exemplary infusion medium containment stem subassembly 7 that has a partial triangular shaped base, has a grip knob 2, a stem 1, and ends with an upward facing tapered point 4 to aid in piercing fruit, vegetables, herbs and other flavor mediums. Once the flavor mediums are inserted onto stem 1 they are held in place anchored to stem 1 with radius bend 26 and 27 aiding to hold them in place.

FIG. 2I illustrates exemplary infusion medium containment stem subassembly 7 that has twin tension fingers 1 which locate reflected from one another at grip knob 2, and are tangent at both their top and bottom juncture with the bottom juncture having articulating fingers to hold the flavor mediums 16.

FIG. 2J illustrates exemplary infusion medium containment stem subassembly 7 having a top grip loop 2 which is a continuation of the central stem 1 part and forms a ring to allow it to locate to the pitcher top surface 22 and the wider helix and piercing point 4 as seen in FIG. 2C.

FIG. 2K illustrates exemplary infusion medium containment stem subassembly 7 that has a stem 1 having a planar spiral design and an inward facing tapered termination point 4 to aid in piercing fruit, vegetables, herbs, and other natural or man-made flavor mediums 16.

FIG. 2L illustrates exemplary infusion medium containment stem subassembly 7 that has a helical design as seen in FIG. 2B, but differs in that it has an upward facing tapered termination point 18 to aid in piercing fruit, vegetables and herbs 16, and has a screw helix thread 19 to allow for positive screw attachment to the pitchers lid 2.

FIG. 2M illustrates an exemplary infusion medium containment stem subassembly 7 having a zigzag shape, and a grip knob 2, a zigzag stem 1 part, and ending in a faired disk shape part 20 which aids in retaining flavor mediums on the substantially vertical stem 1.

FIG. 2N illustrates an exemplary infusion medium containment stem subassembly 7, and employs a flexible stem cord 1 made out of flexible stainless steel braided wire or cable, nylon monofilament line, or other flexible single wire so as to allow the piercing chamfer 18 of part 19 to thread through flavor mediums and have end part 19 attach to the underside of lid 2 forming a containment loop with flexible stem cord 1.

FIG. 2O depicts a flexible stem cord 1 which has the same end finish as seen on stem cord 1 of FIG. 2N. The stem cord 1 is made out of a flexible material and ends in a tapped piercing part 19 which threads through flavor mediums and having a end part 20 which flairs out to contain flavor mediums 16 to flexible cord 1.

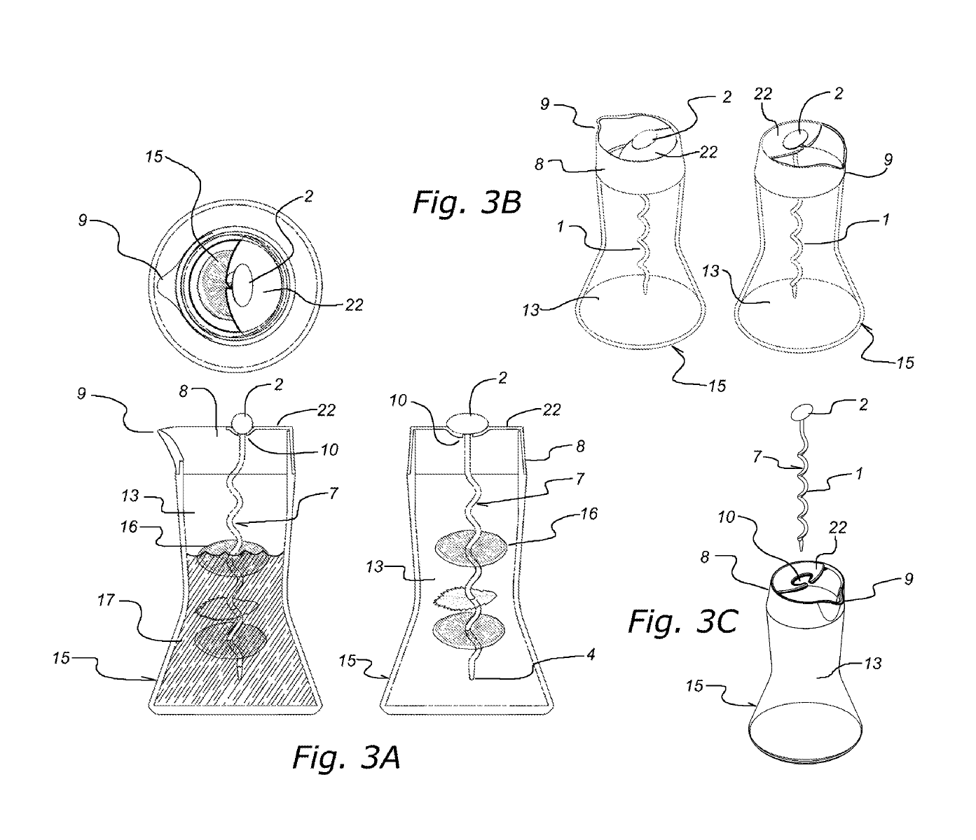

FIG. 3A illustrates three orthographic views; top, side, and front views showing an exemplary beverage infusion pitcher 15, without a handle. Assembly 7 is shown centered inside the pitcher. The grip knob part 2 and assembly 7 positively locates to a slotted recess 10 in the top fixed partial planar surface 22 on the pitchers top part 8.

FIG. 3B illustrates two perspective views showing the infusion pitcher of FIG. 3A, with the stem subassembly 7 mounted without flavor mediums in place. The grip knob part 2 is shown located into the recess 10 in the top fixed partial planar surface 22.

FIG. 3C illustrates a perspective view with the stem subassembly 7 raised above the infusion pitcher 15. The grip knob part 2 will positively locate by partially intersecting into the recess void 10 in the top fixed partial planar surface 22 which is sized and has concave side walls to allow more then half of the bulbous shaped grip knob to rest above this void 10.

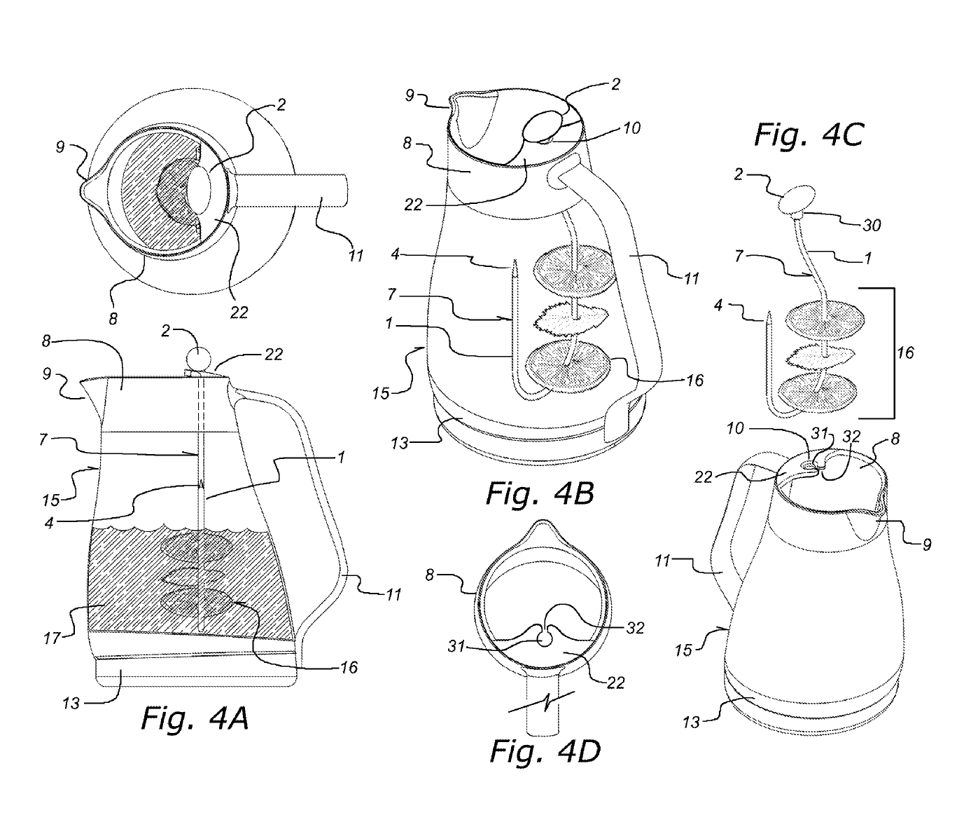

FIG. 4A illustrates a top and side view of an exemplary large capacity infusion pitcher 15, which contains a handle 11, a stem subassembly 7, a “U” shaped stem 1 that ends with a tapered point 4 to aid in piercing fruit, vegetables and herbs 16, and has a grip knob 2. Grip knob 2 also aids to locate and retain stem assembly 7 into recess void 10 on part 8.

FIG. 4B illustrates a perspective view of an exemplary large capacity infusion pitcher 15 with stem subassembly 7 containing flavor mediums 16 shown inserted into pitcher 15 which is staged to contain an edible beverage of the consumers choice.

FIG. 4C illustrates a perspective view of an exemplary large capacity infusion pitcher 15 with stem subassembly 7 containing flavor mediums 16, shown raised above the pitcher and includes a view of the slotted recess notch 10, which retains stem assembly 7 at point 30 of grip knob 2.

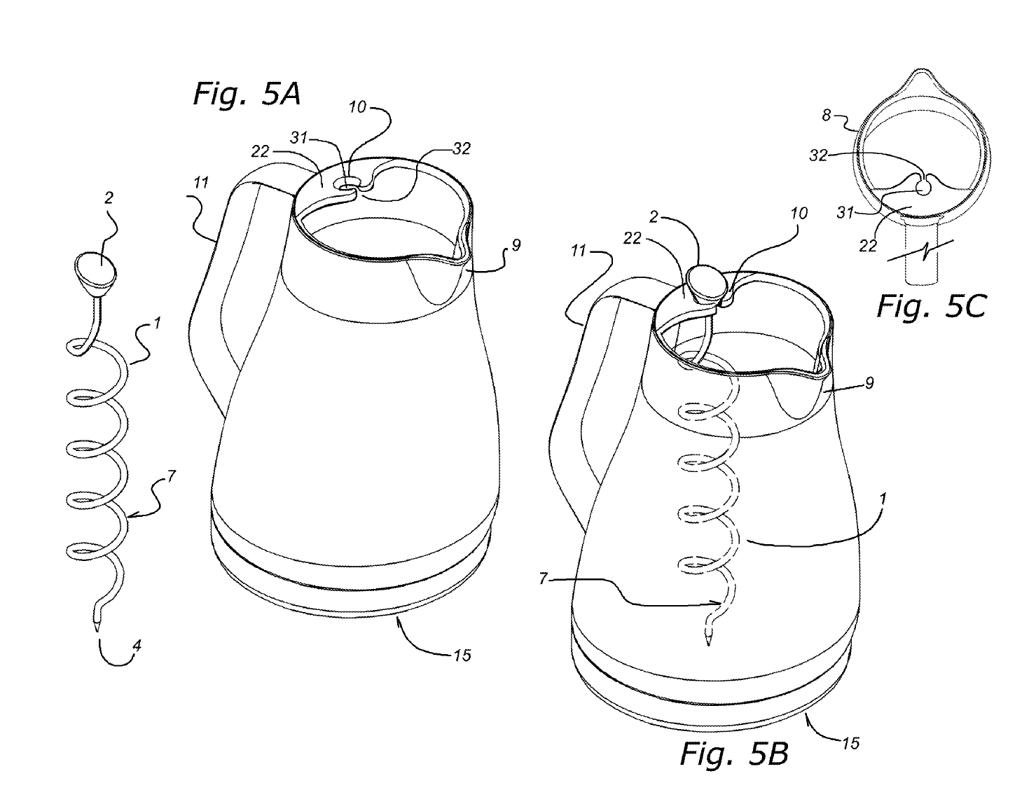

FIG. 5A illustrates a perspective view of an exemplary large capacity infusion pitcher 15 with stem subassembly 7 shown outside of the pitcher. The slotted recess void 10 of top fixed partial planar surface 22 allows for the stem assembly 7 to positively locate to the pitcher and stay in place when the pitcher is being poured. Grip knob 2 has an underside that is a tapered conical shape or radius shape that allows for it to friction nest into the receptor void 10.

FIG. 5B illustrates a perspective view of an exemplary large capacity infusion pitcher 15 with stem subassembly 7 shown located to the pitcher 15. The recess void on the top fixed partial planar surface 22 contains and locates stem assembly 7 to pitcher 15.

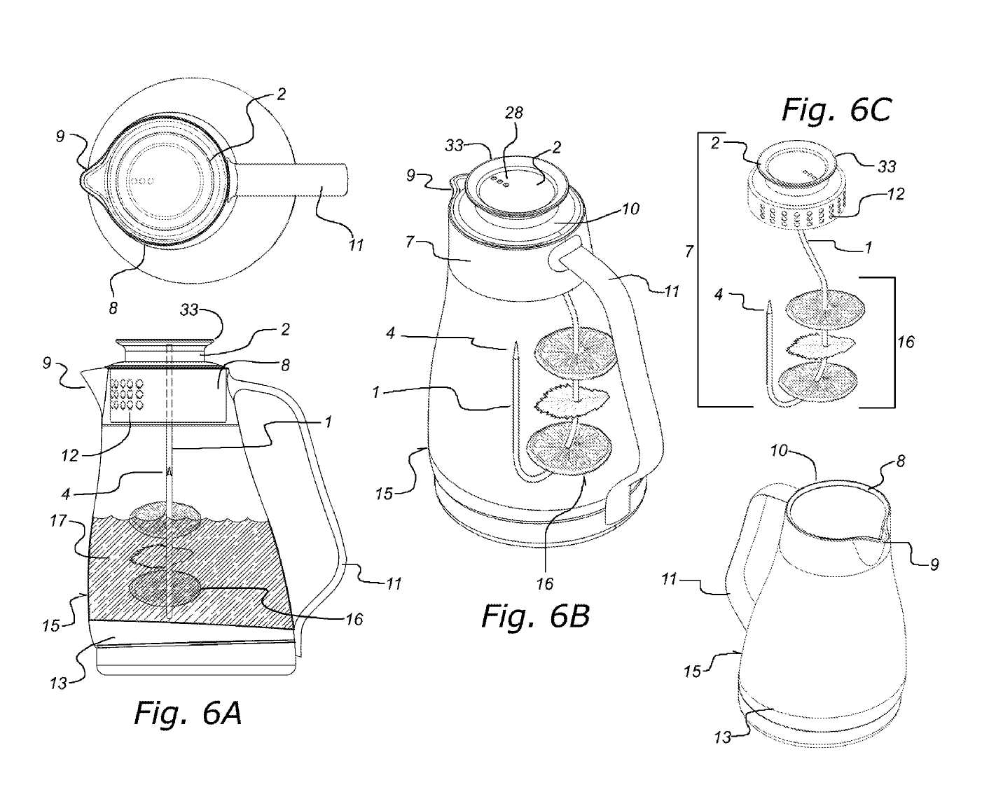

FIG. 6A illustrates a top and side view of an exemplary large capacity infusion pitcher 15, which contains a handle 11, a “U” shaped stem 1 attached to the removable lid 2 and ending with a tapered point 4 to aid in piercing fruit, vegetables and herbs. Stem 1 is screw or friction inserted into a receptor hole in the underside of lid 2. Lid 2 has a multitude of through holes 12, on its front vertical face, tangent to the pitcher's pour spout.

FIG. 6B illustrates a perspective view of an exemplary large capacity infusion pitcher 15 with components as seen in FIG. 6A illustration and with graphic indicators on top lid at point 28 to aid user in orienting the lids pour filter 12, tangent to spout 9.

FIG. 6C illustrates a perspective view of an exemplary large capacity infusion pitcher 15 with components as seen in FIG. 6A illustration and with the Stem assembly 7 shown located outside the pitcher.

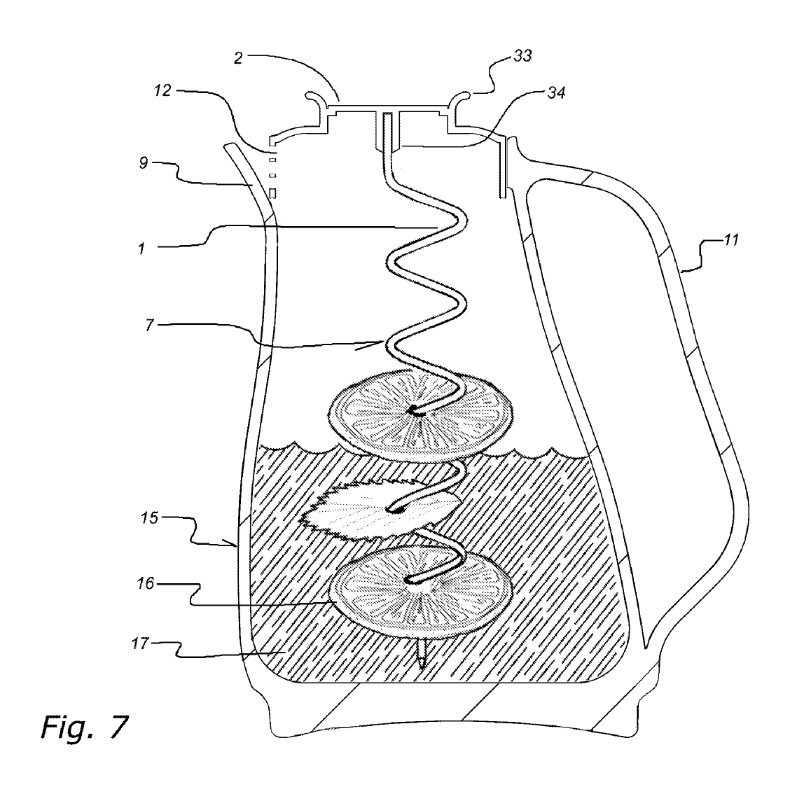

FIG. 7 illustrates exemplary large capacity infusion pitcher in section view with the same design and components as seen in FIG. 6A and shows the stem assembly 7 inserted and retained into the lid part 2.

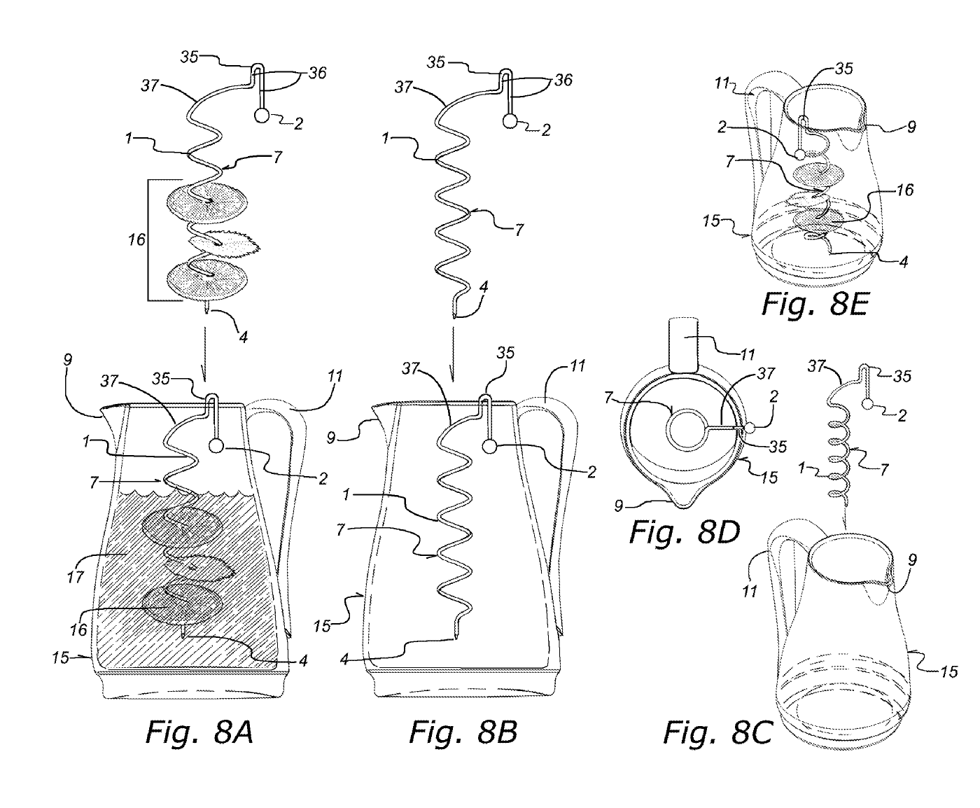

FIG. 8A illustrates a side view of a user supplied standard large capacity infusion pitcher 15, which contains the inventions helical shaped stem option and a new 180 degree radius bend 35 at the top most point of stem subassembly 7 and having a grip knob 2 at its end. The opposite end of stem subassembly 7 has a downward facing tapered point 4 to aid in piercing fruit, vegetables and herbs. The bend 35 functions to locate stem subassembly 7 to the top rim of the pitcher 15 and would flex some to allow for press fitting onto this rim. This allows stem 7 to friction hold to the side of the pitcher and keep the flavor medium(s) 16 submerged in the beverage 17.

FIG. 8B illustrates a side view of a user supplied standard large capacity infusion pitcher 15, with components as seen in FIG. 8A illustration but without beverage 17, and with the stem assembly 7 shown inside and outside of the pitcher 15.

FIG. 8C illustrates a perspective view of this user-supplied pitcher 15, with stem subassembly 7 shown outside of the pitcher 15.

FIG. 8D illustrates a top view of the infusion pitcher 15, with components as seen in FIG. 8B.

FIG. 8E illustrates a perspective view of infusion pitcher 15, with components as seen in FIG. 8B and with the addition of the flavor mediums 16.

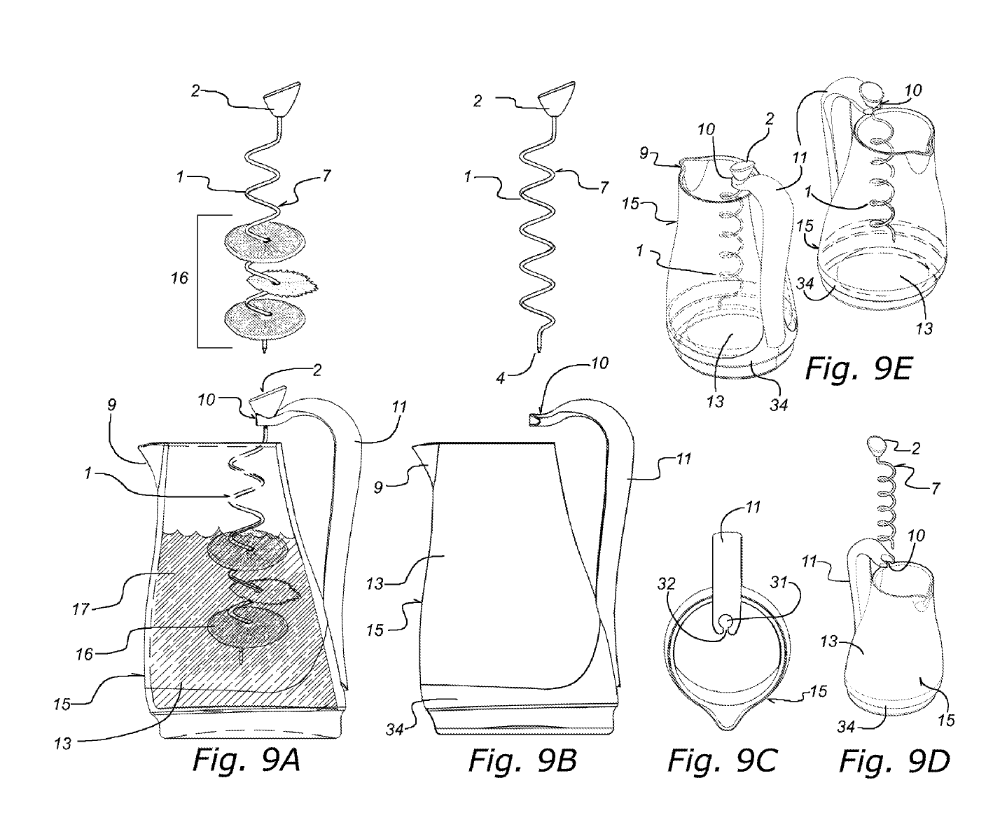

FIG. 9A illustrates a side view of an exemplary large capacity infusion pitcher 15, which contains a handle 11, has a grab knob 2, a helical shaped stem that ends with a downward facing tapered point 4 to aid in piercing fruit, vegetables and herbs, and has a grab knob part 2. The grab knob 2 locates into a slotted recess in the top end of the handle 11.

FIG. 9B illustrates a side view of an exemplary large capacity infusion pitcher 15, with components as seen in FIG. 6A illustration and with the stem assembly 7 shown outside of the pitcher 15.

FIG. 9C illustrates a top view of the infusion pitcher 15, with depicting on the top of handle 11a keyhole 31, and slot 32 which allow for the insertion and positive locating of stem subassembly 7,

FIG. 9D illustrates a perspective view of the infusion pitcher 15, with components as seen in FIG. 6A illustration and with the stem assembly 7 shown outside of the pitcher 15. The grab knob 2 has an underside with a substantial conical ending allowing it to nest to a void in the handle made up of a through hole slot in the handle leading to an inverse void of the shape of the underside of part 2 as seen location 10 at the top of handle 11.

FIG. 9E illustrates two perspective views of the infusion pitcher 15, with components as seen in

### DETAILED DESCRIPTION OF THE ILLUSTRATED EMBODIMENTS

It should be understood at the outset that although illustrative implementations of one or more embodiments are illustrated below, the disclosed components and subcomponents may be implemented using any number of techniques, whether currently known or in existence. The disclosure should in no way be limited to the illustrative implementations, drawings, and techniques illustrated below, but may be modified within the scope of the appended claims along with their full scope of equivalents.

As described in more detail below, the invention according to the first aspect of the disclosure includes a flavor infusion pitcher which makes ready to consume custom beverages when flavor mediums such as fruit, vegetables, herbs, or other desirable natural or manmade flavor enhancers are positioned on or between a substantially central stem in a pitcher and a desired hot or cold beverage is made to surround these flavor mediums. The flavor mediums will remain contained on said central stem and will transfer flavor to the beverage contained inside the pitcher which surrounds these said flavor mediums, while at the same time said flavor mediums are presented in a location which has high visual appeal to the end user.

Referring to the drawings, a preferred embodiment of this invention is shown in FIG. 1A pitcher and infusion subassembly combination. The combination shown in FIG. 1A incorporates a pitcher 15 and an infusion subassembly stem 7, which retains a wide variety of edible ingredients exemplary of the flavor mediums 16 as shown in FIG. 1B. Stem 7 is designed to terminate with a tapered pointed end 4, have a helical shaft part 1, and have a grip knob part 2. Grip knob 2 nests in a recess receptor designed into the half cover on the top of the pitcher part 8 on surface 21. This top surface 21 also has an opening that is approximately half the top mouth area where the beverage is dispensed from and directed out of spout 9. Part 1 in this embodiment is designed to be helical along a vertical axis so as to allow the fruit and herb leaves 16 to locate anywhere along it's vertical length. The fruit and herbs 16 will infuse flavor to the tea or water as they remain in contact with one another. As the user pours the contained tea or water out of the pitcher, the stem assembly 7 will remain in place retaining the fruit and herb leaves so that only the infused liquid exits out when poured. The flavor infusing medium ingredients 16 are pierced onto stem 1 shown in FIG. 1C and this stem subassembly 7 is then inserted into the pitcher 15 and water, tea or other edible liquid 17 is then added to the pitcher. FIG. 1D shows the inherent advantage to having the flavor infusing mediums contained on stem subassembly 7 when pouring infused beverages 17 from the pitcher 15. All flavor infusion mediums 16 are keep inside the pitcher and do not spill out into the drinking glass 29 while pouring. Stem subassembly 7 stays located to the slotted recess 10 in the top peripheral frame 21. Stem 7 locates into a recess notch 10 in part 8 on its top plane 21 and will stay in place allowing only the infused liquid to exit out of the pitcher when poured, leaving the infusion medium(s) 16 located to stem 7 subassembly inside pitcher 15. FIG. 1E shows the grip knob 2 and stem subassembly 7 slidably inserted into pitcher 15 top finish part 8 with exemplary flavor infusion mediums 16 in place on stem 1. In its preferred embodiment the pitchers top part 8 is to be injection molded food safe plastic and beverage vessel 13 is to be made of glass or clear plastic. FIG. 1F illustrates a sectional view of pitcher grip knob 2 and stem subassembly 7 in an alternate arrangement for fastening stem subassembly 7 to pitcher top 8. Grip knob 2 has a pair of interference tabs 24 that flex to allow stem assembly 7 to be press-fit into opening 10 and when in place, these tabs flex to their rest position to allow for subassembly 7 to be held to part 8. A deliberate lifting force will allow assembly 7 to then dismount from part 8.

In some embodiments, the stem subassembly 7 will have the configuration seen in FIG. 2A which depicts the stem 1 having a “U” shaped profile with a semicircular radius 6 allowing stem 1 to end in an upward facing vertical direction. The stem 1 terminates in a pointed end 4 to aid in piercing flavor mediums and retained them on stem 1. Grip knob 2 has an underside protrusion 30 which extends downward that allows subassembly stem 7 to locate to the pitcher top part 8, vertically inserting to keyhole 31 void as seen in FIG. 4C. FIG. 2B. depicts a configuration for stem 1 that has a vertical helical axis and ends with a bottom planar circular finish 3. This circular finish 3 helps to retain the flavor medium 16, so that they do not fall off the stem 1 part. The stem 1 terminates in a pointed end 4 to aid in piercing flavor mediums and retaining them on stem 1. FIG. 2C shows an alternate configuration for subassembly 7 in which the helix has a larger diameter. This larger diameter ensures that the flavor medium 16 do not fall off or slide down the stem 1 once inserted because the intersection tangency to the flavor medium(s) 16 is non-vertical intersection and gravity is less likely to pull the fruit or other flavor medium downward. The stem 1 terminates in a pointed end 4. FIG. 2D shows the subassembly stem 7 seen in FIG. 2C with flavor mediums attached and positively held in place on helix stem 1.

FIG. 2E shows subassembly stem 7 having a zigzag profile. This zigzag design aids in retaining flavor medium(s) 16, and keeps them from dislodging from stem 1 while also keeping them held in place while submerged in a beverage in the event they are positively buoyant in a surrounding beverage. The embodiment shown in FIG. 2F utilizes a torsion spring like stem 1 on the lower half of this subassembly 7 which allows stem 1 to expand and exert tensile force on the flavor mediums that are threaded onto or placed between it's flexible helical bottom. The flavor mediums 16 are either inserted onto stem 1 at tapered end 4, or are held between stem 1 with the lateral helix exerting tension against these flavor mediums. FIG. 2G depicts a stem subassembly 7 with several smaller stems 24 that extend outward from the main stem 1 and each having a tapered termination point 4 to aid in piercing of the flavor medium(s) 16. Once these flavor mediums 16 are inserted onto stems 4 they are held in place anchored to the lateral stems. The stems 24 can have optional detailing of having concentric ribbing 25 or raised barbs 39 to further aid in retaining the flavor medium 16 to said stems 24. FIG. 2H is an embodiment of stem assembly 7, which depicts a variation of stem 1 that has a lower partial triangular profile with horizontal bottom and a vertical return pointed termination end 4. Radius corners 26 and 27 aid in keeping flavor mediums retained onto stem 1 by keeping gravity from pulling the flavor medium(s) off of stem 1.

FIG. 21 embodies a subassembly 7 which features a two part stem 1 that is assembled and held together by grip knob 2 so as to have stored lateral tension at its bottom ends 4 and vertical bowed parts 1 which allow this stem subassembly 7 to positively hold flavor mediums under tension in their desired along stems 1. The 2 opposing stem 1 parts flex apart from one another under tension, and terminates with twin inward facing grip points 4, which aid in holding fruit, vegetables, herbs, or other flavor mediums between stems 1 while under tension. Once these flavor mediums are placed between the tensioning fingers 1, they are positively held in place. FIG. 2J depicts a subassembly 7 part which is comprised of a single rod stem 1. At its top is a grip ring 2 formed by a continuation of the central stem 1 and this ring will aid in allowing this stem subassembly 7 to locate to the pitcher top planar surface 22 of part 8 of pitcher 15. This grip loop 2 is to be inserted through-hole slot 32 and located into a keyhole 31 as seen in FIG. 3C for pitcher top part 8. FIG. 2K depicts a subassembly 7 part that has a stem 1 having a planar spiral design and an inward facing tapered termination point 4 to aid in piercing fruit, vegetables, herbs, and other natural or man-made flavor mediums 16. This inward progressing spiral allows for flavor mediums to be threading onto stem 1 with each additional flavor medium added causing the previous one to move closer to the radius bend 38 on stem 1. This stem part 1 is positively attached to the grip knob 2 through a screw thread, welding, soldering or other desired interface. Grip knob 2 also has a protrusion 30 which will allow stem assembly 7 to locate to the recess void 31 in pitcher 15 into top part 8 as seen in FIG. 4C.

FIG. 2L depicts a stem subassembly 7 part in disassembled and assembled perspective views. The stem 1 screws to an underside recess in lid part 2. The attachment of stem 1 and lid 2 can also be a friction press-fit, a detent snap fit, or other means, which ensure positive engagement and disengagement. Flavor mediums 16 are inserted onto the stem 1 on its top tapered termination end 18. Screw threads 19 on part 1, allow it to positively screw attach to lid 2 at its underside recess which has receptor female threads. Stem 1 has a bottom with a planar circular radius bend 3, which ensures the flavor medium(s) are retained on stem 1 above this point. Once these flavor medium(s) 16 are inserted onto stem 1 they are held in place anchored to the skewer 1. The stem 1 can then be screwed back to attach to lid 2. Lid 2 also functions as the containment cover for the beverage pitcher. Refer to FIG. 6A through FIG. 6C for assembled embodiment of lid 2 as shown in an exemplary pitcher. FIG. 2M depicts a zigzag profile shape variation to stem 1, which has the same end finish as seen on the stem 1 of FIG. 2J. This stem part 1 screw attaches to the grip knob 2. Grip knob 2 also has a protrusion 30 which will allow stem assembly 7 to locate to the recess void 31 in pitcher 15 into top part 8 as seen in FIG. 4C. Other intersection means between stem 1 and lid 2 are ascertainable by one skilled in the art and could be made without departing from the spirit and scope disclosed herein. Stem 1 lower termination has a disk shape 20 that is several times larger then the diameter of the stem 1, aiding to function as a planar stop and retaining the flavor medium(s) 16 above it.

FIG. 2N depicts a flexible stem 1, which has a lower termination point 19 and an upper termination point at lid 2 as seen on stem part 1 of FIG. 2K. The stem part 1 is made out of a flexible material such as stainless steel cord, nylon monofilament line, or other flexible single wire means so as to allow the piercing taper termination point 19 on part 18 allowing flavor medium(s) to be pierced and contained on the flexible wire, cord, or monofilament line. Once the flavor mediums are threaded onto the cord or wire, end part 19 inserts into screw, friction, or a snap-fit mountable recessed hole on the underside of lid 2 and this subassembly 7 can then be mounted to the pitcher 15. FIG. 20 depicts a flexible stem part 1 which has an end finish as seen on stem part 1 of FIG. 2N. The stem part 1 is made out of a flexible material such as stainless steel cord, nylon monofilament line, or other flexible single wire means, so as to allow the piercing taper point 18 of part 19 the ability to thread through flavor medium(s) 16, piercing through them as the tread onto and are contained by the flexible cord. Once the flavor mediums are threaded onto the cord or wire, end part 19 inserts into screw, friction, or a snap-fit mountable recessed hole on the underside of lid 2 and this subassembly 7 can then be mounted to the pitcher 15.

The inventions preferred embodiment shown in FIG. 3A, FIG. 3B, and FIG. 3C detail the assembly and how subassembly stem 7 is to be inserted into the pitcher 15 at the top surface 22 into keyhole opening 10 of top part 8. FIG. 3A shows 2 sectional views of the pitcher 15 with and without beverage 17 added. FIG. 3B shows 2 opposite facing perspective views of pitcher 15 without flavor medium(s) 16. FIG. 3C shows stem subassembly 7 raised above the slotted keyhole recess 10 which grip knob 2 partially intersects to be held in place.

FIG. 4A, FIG. 4B, FIG. 4C, and FIG. 4D depict a larger capacity pitcher with a similar upper embodiment and design as seen in the smaller capacity pitcher shown in FIG. 3 but with the addition of a handle 11. FIG. 4A also depicts a side and top view of the pitcher 15 with the flavor medium(s) 16 located in it's preferred location on stem 1, and fully submerged in beverage 17 for maximum flavor transferal. Grip knob 2 has an underside protrusion 30 which locates into keyhole 31 at point 10 of top plane 22 as seen in FIG. 4C. Keyhole 31, as seen in FIG. 4D, would have a contour tangency slightly larger then that of protrusion 30, allowing said protrusion to intersect and be retained to plane 22, and for the upper portion said grip knob to be held above plane 22 to aid in gripping this part. The insertion of stem subassembly 7 into top part 8 ensures they remained contained to one another at rest and during pouring of beverages contained in pitcher 15. The lead-in slot 32 in part 8 in front of said keyhole 31, would be slightly larger then that of the diameter of stem 1 to allow inserting stem subassembly 7 through this slot and drop locating grip knob 2s bottom protrusion 30 into the keyhole receptor 31. The protrusion 30 of part 2 could have optional designs to allow for a slight interference, friction, or detent fit, so as to allow a positive snap-fit of stem subassembly 7 to the pitcher top part 8.

FIG. 5A and FIG. 5B illustrate a large capacity infusion pitcher 15, with handle 11, showing the stem subassembly 7 outside and inside of the pitcher 15. The recess void 10 in the top of part 8 allows for the stem subassembly 7 to positively locate to the pitcher at point 31 and stay in place when the pitcher is being poured. FIG. 5C shows a top view of part 8 and top plan 22 with detail views of the keyhole 31 and slot 32 void areas in this part.

FIG. 6A, FIG. 6B, and FIG. 6C depict a similar stem subassembly 7 as seen in FIG. 2K with a simplified stem part 1 having a “U” shape. The stem part 1 could be removable or non-removable from lid part 2, and would stay mounted to lid part 2 when user adds or removes stem subassembly 7 from pitcher 15. Stem part 1 and Lid 2 can dismount from one another to allow for retail packaging, cleaning, or replacement requirements. Lid part 2 has perforated holes 12 as seen just opposite the pour spout 9 as seen in FIG. 6A, which allow the lid to filter-out any pulp, undesirable solids, or semi-solids during pouring beverage 17 from the pitcher 15. A top grip rim 33 on lid 2, aids the user in removing this stem subassembly 7 from pitcher 15. Pitcher 15 could be sold with several uniquely configured stem part 1 pieces in the event the consumer benefits from the ability to match customized stem 1 parts to the needs of specific beverages 17 or flavor infusion medium(s) 16. Unique configurations and customization of stem part 1 to match functional needs of individual infusion mediums and beverages is ascertainable by one skilled in the art and could be made without departing from the spirit and scope disclosed herein.

FIG. 7 shows a sectional view of the pitcher depicted in FIG. 6 embodiments where the lid 2 and stem part 1 are mated together, and together from the single subassembly 7 which is removable from the pitcher 15. Flavor medium(s) 16 can be added to stem part 1 while it remains connected to lid part 2 at point 34. The connection of stem 1 to lid 2 can be a press-fit, screw fit, snap detent fit, or other means which are ascertainable by one skilled in the art and could be made without departing from the spirit and scope disclosed herein. As with FIG. 6 embodiment, a grip area rim 33 is integral to lid 2 and aids in removing the subassembly 7 from the pitcher 15. Lid 2 has perforated holes 12 which allow the said lid to filter-out any pulp, undesirable solids, or semi-solids during pouring beverage 17 from the pitcher 15.

FIG. 8A through FIG. 8E are exemplary depictions of a user supplied beverage pitcher 15 where the invention shown is exclusively limited to the stem assembly 7. This stem assembly 7 locates to the users desired beverage containment vessel 15. It is within the scope of this disclosure that this embodiment of stem assembly 7 can be designed and scaled to fit to a wide array of beverage pitchers, drinking glassware, or single use beverage containers and the helical stem 1 shown can be substituted to be an alternate stem design, such as, but not limited to the exemplars disclosed in FIG. 2A through FIG. 2N and contained within. FIG. 8A illustrates a side view where the stem 1 is helical in shape, has a 180 degree radius bend 35 at the top most point of stem assembly 7 and has a stem extension segment 37, which directs the stem's central vertical helix towards the center of said pitcher. A grip knob 2 terminates the upper downward facing stem 1 and aids in the insertion and removal of stem assembly 7 from the said beverage containment vessel. The opposite termination point of stem 1 has a downward facing tapered point 4 which pierces fruit, vegetables, herbs, and other flavor medium(s) 16. The top radius arch 35 of stem 1 allows for a deliberate close tangency of the two parallel stem segments 36. This arch 35 and parallel stem segments 36 will flex under tension to allow stem assembly 7 to positively locate with tension onto the top rim of the user supplied pitcher or beverage containment containment vessel 15. Stem assembly 7 will friction-hold to the pitchers top and keep the flavor medium(s) 16 submerged in the beverage 17 even when the favor medium(s) are buoyant.

FIG. 8B illustrates a side view of a user supplied standard beverage pitcher 15, with components as seen in FIG. 8A illustration but without containing beverage 17 or flavor medium(s), and with the stem assembly 7 shown inside, secured onto the pitcher 15 at its top rim. This stem subassembly 7 is also depicted in a repeated view above pitcher 15.

FIG. 8C illustrates a perspective view of this user supplied beverage pitcher 15, with stem assembly 7 shown outside of the pitcher 15.

FIG. 8D illustrates a top view of the user supplied beverage pitcher 15, with components as seen in FIG. 8B. Stem extension segment 37 is shown which allows the central helical stem 1 to locate substantially to the center axis of pitcher 15.

FIG. 8E illustrates a perspective view of the user-supplied pitcher 15, with components as seen in FIG. 8B and with the addition of exemplar flavor medium(s) 16.

FIG. 9A through FIG. 9E are exemplary of infusion pitcher 15 where the handle 11 extends up and over the top finish of the pitcher to allow for a mounting support for stem subassembly 7. FIG. 9A shows a side view of infusion pitcher 15 containing a beverage 17, a grip knob 2, and a stem subassembly 7 positively located to handle 11 and a repeated view of the stem assembly 7 shown above the said pitcher. A recess slotted void in handle 11 at point 10, is configured to be the inverse tangency of the lower half of grip knob 2. FIG. 9B shows Grip knob 2 having an underside that is substantially conical or hemispherical and tapered to allow it to be held by the inverse of this shape which is voided out of handle 11 at its top 10 area. Keyhole 31, and slot 32 in handle 11 allow for the insertion and positive locating of stem subassembly 7 as seen in FIG. 9C and FIG. 9D. FIG. 9E depicts two assembled perspective views of the infusion pitcher 15 without beverage or flavor mediums. In its preferred embodiment, this infusion pitcher 15 would have vessel part 13 made of glass or clear plastic and have a secondary plastic base part 34 which would be molded to have an integral handle 11 as depicted in the left view of FIG. 9E.

While several aspects of the disclosure have been provided above, it should be noted that the disclosed exemplars, assemblies, and subassemblies may be embodied in many other specific forms without departing from the spirit or scope of the present disclosure. The present disclosure is considered as illustrative and not restrictive, and various elements or components from one or more of the above described aspects of the disclosure may be combined or integrated together or certain features may be omitted. Similarly, any of the various elements or components described in conjunction with one of the above aspects of the disclosure may be combined with or may replace corresponding elements or components of any of the other aspects of the disclosure. Other examples of changes, substitutions, and alterations are ascertainable by one skilled in the art and could be made without departing from the spirit and scope disclosed herein.

Having thus described the invention, what is claimed is:

1. A flavor infusion pitcher comprising:
(A) a pitcher having side walls, a closed bottom, and upwardly substantially open mouth opposed to said bottom, a spout adjacent to said mouth, an optional removable lid that locates to said mouth, an optional top circumferentially peripheral frame, an optional handle, and a substantially vertically orientated interior skewer device which is removable and locates to pitcher at said mouth, said lid, said top circumferentially peripheral frame, or said handle.
B) a top circumferentially peripheral frame and lid structure that is associable with said pitcher and said skewer subassembly comprising:
a partial or fully covering lid structure which is engaged and removable from said mouth, said lid structure comprising of a cap portion having a receptor recess wherein said skewer mounts and extends downward towards bottom of said pitcher.
a top circumferentially peripheral frame comprising of a partially lateral extending lid surface of said pitcher wherein said skewer locates to and is removable, and said frame and lid surface is fixed to the top of the pitchers open mouth, forming a partial cover circumferentially tangent to the top edge of the side walls opposite said spout extending laterally towards said spout forming a surface having a substantially centered recess for the skewer subassembly to intersect and locate to.
(C) a skewer subassembly that is disassociatively associatable with said pitcher, said skewer subassembly comprising in combination:
containing a grip knob slidably engaged and removable from said partial lid structure and containing a shaft, which extends downward to the interior base of said pitcher.
a shaft which is substantially vertical and removable from said pitcher, has one of two termination points ending in a tapered point, and is joined at the other end to said grip knob and is longitudinally inserted through the open mouth of said pitcher.
a grip knob which is dedicated and fastened to the top termination end of said shaft.
an optional removable lid structure which is dedicated to said pitcher and allows for said shaft to be joined to, eliminating the need for the grip knob.
a grip knob which is connected to said shafts upper termination end, and when inserted to pitcher, stays fitted and engaged to said pitcher during dispensing of liquid from said pitcher when it is angularly deflected and will stay located substantially central to a lid, the pitchers mouth opening, a handle, or a top peripheral frame during this deflection and also in the pitchers non-deflected, vertical at rest position.
the ability to retain flavor mediums such as fruit, vegetables, herb leaves, manmade flavor enhancer inserts, and keep them submerged in liquid contained in said pitcher.
(D) a handle that is fixed to the pitchers said side walls, top, or base, and is opposite said spout and extends upward vertically and returns in a lateral direction, partially extend over said pitchers open mouth to allow said skewer subassembly to locate to and be easily removed.

2. A flavor infusion pitcher which comprises a removable, insertable stem assembly that intersects or exerts tension against flavor mediums such as fruit, herbs, vegetable, or other natural or manmade flavor enhancer inserts, and holds them submerged and surrounded by beverage contained within said pitcher, even when said pitcher is angularly deflected to pour the beverage.

3. A flavor infusion stem assembly which locates under tension to the top circumferentially edge rim of a user supplied beverage vessel where said stem assembly intersects or exerts tension against flavor mediums such as fruit, herbs, vegetables, or other natural or manmade flavor enhancer inserts, and holds them submerged and surrounded by beverage contained within said beverage vessel, allowing beverage to be poured or drank from said user supplied beverage vessel without said flavor mediums being dispensed.

4. A flavor infusion pitcher of claim 2 comprising a removable, vertically inserted stem, which retains pieces of fruit, herbs, vegetables or other flavor enhancing mediums which can embody natural or manmade flavor enhancer inserts.

5. A flavor infusion pitcher of claim 2 wherein the substantially centered removable skewer is shaped in a variety of ways to best retain the desired flavor medium while inserted and positioned substantially vertical inside a liquid beverage containing pitcher.

6. A flavor infusion pitcher of claim 2 comprising a substantially central shaft to allow for flavor medium such as fruit, vegetables and herbs to intersect with or be held in tension so that they can be suspended inside a retained volume of digestible liquid contained inside the pitcher.

7. A flavor infusion pitcher of claim 2 wherein said sealable lid structure is additionally provided which is removable from said pitchers substantially open mouth.

8. A flavor infusion pitcher of claim 2 comprising of a removable interior skewer.

9. A flavor infusion pitcher of claim 2 wherein the pitchers top edge contains a top partial peripheral frame, which holds a removable central skewer subassembly.

10. A flavor infusion pitcher of claim 2 wherein said skewer extends centrally between said side walls of pitcher and allows for said flavor mediums to be submerged in a beverage contained in the pitcher.

10. A flavor infusion pitcher of claim 2 which has the ability to retain sliced or whole fruit, vegetables, herbs or other flavor enhancing mediums both natural or manmade, within a consumable liquid and allows the end user to dispense the resulting flavor infused liquid into a drinking glass without the flavor medium(s) leaving the pitcher.

11. A flavor infusion pitcher of claim 2 which when filled with a digestible liquid, will fully surrounds the interior flavor medium(s) which are contained on a substantially central axial stem subassembly.

12. A flavor infusion pitcher of claim 2 in which the interior retained flavor medium(s) will remain submerged in a surrounding liquid even when the flavor mediums are buoyant in the digestible liquid.

13. A flavor infusion pitcher of claim 1 which comprises a flavor containment device that is removable and can be fixed to the pitchers removable lid.

14. A flavor infusion pitcher of claim 2 which comprises an internal substantially flexible skewer for intersecting with and containing flavor mediums.

15. A flavor infusion pitcher of claim 14 which includes a weight or magnet at the end of the internal flexible skewer to aid in retaining flavor medium(s) centered, inside said pitcher, counteracting any inherent buoyancy of said flavor medium(s).

16. A flavor infusion pitcher of claim 15 which includes a magnet inset into the bottom of said pitcher which the flexible skewer magnetic end adheres to, counteracting any inherent buoyancy of said flavor medium(s).

17. A flavor infusion pitcher of claim 2 in which comprises a removable internal skewer that pierces through the flavor medium and further enhances the migration of the flavors to the liquid contained in the pitcher.

18. A flavor infusion pitcher of claim 2 which comprises an internal skewer that has a center stem having multiple smaller lateral stem segments joined to which extend outward from said central stems which are spaced apart from one another and have a tapered end point for piercing through and retaining flavor mediums.

19. A flavor infusion pitcher of claim 18 which comprises an internal skewer(s) that has additional raised lateral segmentations, barbs, or raised ribs to positively secure flavor mediums to said skewer even when skewer is in a vertical orientation.
